(19) United States
(12) Patent Application Publication
(10) Pub. No.: US 2021/0117911 A1
(43) Pub. Date: Apr. 22, 2021

(54) ITEM INVENTORY MANAGEMENT VIA WIRELESS SIGNALS

(71) Applicant: NCR Corporation, Atlanta, GA (US)

(72) Inventors: Anand Chanduri, Hyderabad (IN); Naresh Tummanapalli, Hyderabad (IN)

(21) Appl. No.: 16/658,603

(22) Filed: Oct. 21, 2019

(51) Int. Cl. G06Q 10/08; G06Q 20/20; G07F 9/02; H04W 4/02; H04W 4/029; H04W 4/021

(52) U.S. Cl. CPC G06Q 10/087; G06Q 20/203; H04W 4/021; H04W 4/023; H04W 4/029; G07F 9/026

(57) ABSTRACT

Reflected wireless signals from a wireless transceiver are analyzed for perturbations in known wireless signal patterns associated with different levels of stocking capacity for a given shelf/display having a given item type of items stored thereon. The perturbations are compared against known perturbations for the patterns and a decision is made as to whether a real-time notification is to be sent indicating that additional ones of the items require restocking on the given shelf/display.

### BACKGROUND

Inventories of goods and products are vital to any retailer. Typically, transaction logs and purchase orders are used to track existing product inventory within any given store of a retailer. The purchase orders identify products purchased by the store and the transaction logs identify products sold, the different between counts of products in the purchase orders and counts of products sold indicate the total number of products on hand or in inventory for the store.

However, the actual inventory of products does not reflect a current product inventory on shelves or displays of the store. Yet, availability of products on the shelves that can also result in lost revenue and frustrated customers when a desired product is in inventory but has not been stocked on the store shelves for customer purchases. It is of little benefit to a store to have inventory of a product but not have that product properly stocked on the store on the shelves, since customers are unable to see the product and may not be inclined to ask store staff about the availability of the product; rather, customers are more likely to leave the store frustrated without making a product purchase and as a result may not return to the store for subsequent purchases. Stores can become busy and may be short staffed from time to time, as a result, staff may not even realize when a product is not stocked on store shelves for customer purchase.

A variety of techniques have been attempted in the industry to obtain a more accurate product inventory available on store shelves. Most of these techniques rely on processor-intensive image processing from images of the products on the shelves captured by cameras that are focused on the shelves for item recognition and item counts. Some techniques may utilize customized sensors attached to the products. Nearly all of the techniques rely on specialized hardware dedicated to product-shelf inventory management (e.g., cameras and or sensors).

### SUMMARY

In various embodiments, methods and a system for item inventory management utilizing wireless signals are presented.

According to an aspect, a method for item inventory management utilizing wireless signals is presented. A reflected wireless signal is obtained from a transmitted wireless signal that is reflected off a shelf having items stored on the shelf of a given item type. The reflected wireless signal is compared against known patterns for known reflected wireless signals associated with different inventory levels of the items when present on the shelf. A determination is made as to a current inventory level for the items that are currently present on the shelf based on the comparison. An alert is sent that causes restocking of the shelf with the items of the given item type based on the current inventory level.

### BRIEF DESCRIPTION OF THE DRAWINGS

FIG. 1 is a diagram of a system for item inventory management utilizing wireless signals, according to an example embodiment.

FIG. 2 is a diagram of a method for item inventory management utilizing wireless signals, according to an example embodiment.

FIG. 3 is a diagram of another method for item inventory management utilizing wireless signals, according to an example embodiment.

FIG. 4 is a diagram of another system for item inventory management utilizing wireless signals, according to an example embodiment.

### DETAILED DESCRIPTION

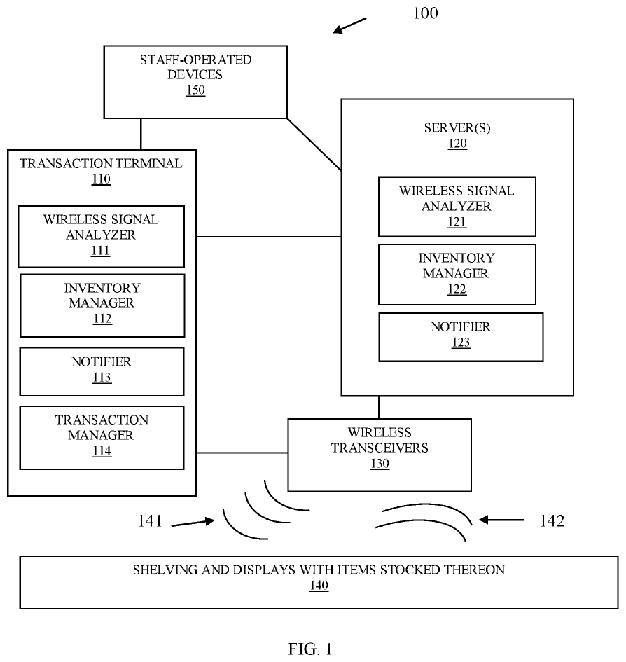

FIG. 1 is a diagram of a system 100 for item inventory management utilizing wireless signals, according to an example embodiment. It is to be noted that the components are shown schematically in greatly simplified form, with only those components relevant to understanding of the embodiments being illustrated.

Furthermore, the various components (that are identified in the FIG. 1) are illustrated and the arrangement of the components is presented for purposes of illustration only. It is to be noted that other arrangements with more or less components are possible without departing from the teachings of item inventory management utilizing wireless signals presented herein and below.

The system 100 includes a transaction terminal 110, a server 120, wireless transceivers 130, shelving and displays with items stocked thereon 140, and staff-operated devices 150. Each device 110-130 and 150 includes its own processor and non-transitory computer-readable storage media comprising executable instructions that are executed by the processor to perform the processing discussed below with respect to the wireless signal analyzer 111, inventory manager 112, notifier 113, transaction manager 114, wireless signal analyzer 121, inventory manager 122, and notifier 123.

Wireless transceivers 130 may be wireless access points or wireless routers that are pre-existing within a store. That is, the system 100 utilizes transceivers 130 within an existing wireless infrastructure of a store to perform novel real-time item shelf inventory management. Transceivers 130 include wireless signals that are sent from their wireless transmitters 141 as wells as wireless receivers that receive signals from transmitting devices (such as devices 110, 120 and 150) and receive signals 140 that bounce off of objects (such as items on the shelving and displays 140).

Signals 142 originate as signals 141 but are alerted/modified when as received back by the transceivers 130 after bouncing off of or being reflected by physical objects situated within the path of original transmitted signals 142. These signals 141 and 142 are available for analysis through admin services associated with the transceivers 130 (other signals are available through the admin services as well such as signals associated with any connected device 110, 120, and/or 150).

Wireless signal analyzer 111 and/or 121 obtain signals 142 from the admin services of transceivers 130 and are analyzed for predefined and unique perturbations. Initially, wireless signal analyzer 111 and/or 121 are preconfigured to associate specific shelves or displays 140 having specific items within known unique perturbations in signals 142 for each shelf and each item type. Each shelf and corresponding item type assigned or associated with a set of known unique perturbations including unique perturbations for: when the shelf is completely full with the items, when the shelf is ⅔rds filled with the items, when the shelf is ½ filled with the items, when the shelf is ⅓^{rd} filled with the items, and when the shelf is empty and without any item stocked thereon.

Wireless signal analyzer 111 and/or 121 uses the known perturbations in signal 142 to determine when a given shelf with a given item type requires restocking on the given shelf by matching received perturbations in signal 142 against the known perturbations. The matching is not a direct matching (although in some cases this may be); rather, a scoring and weighting technique may be used to compare a real time signal 142 against the known perturbations. In this way, variations between the known perturbations can be detected.

Wireless signal analyzer 111 and/or 121 provides results of the comparison between a received signal 142 and known perturbations to inventor manager 112 and/or 122. Inventory manager 112 and/or 122 uses rules for a given item associated with a given shelf along with results provided by wireless analyzer 111 and/or 121 to determine when an alert should be sent to notifier 113 and/or 123 for a given item type on a given shelf of the store.

Notifier 113 and/or 123 may utilize rules based on a given item type and or given shelf identifier to send a real-time notification to staff-operated devices 150. Such notices may be customized via the rules to provided customized content that is sent to specific store personnel. For example, a stocking clerk operating a mobile device 150 may be sent a message stating Coco Cola® on aisle 5, shelf 1 is now only ⅓^{rd} full, or Dove® soap in aisle 2, shelf 4 is now empty. The rules may also indicate that notifier 113 and/or 123 should send an Application Programming Interface API message to an in-store inventory management system that tracks all current available stock in the store for a given item type. Based on the message, in-store inventory management system may determine to trigger a purchase order of a given item type from a vendor to ensure the inventory of the given item type within the store remains at a preconfigured threshold level.

In an embodiment, wireless signal analyzer 111 and/or 121 are also preconfigured to recognize when a given signal 142 includes noise, such that the signal 142 should be disregarded and another signal 142 taken and evaluated. The noise may be associated with perturbations in signal 142 associated with people or carts being in-front or between transceivers 130 and shelving and displays 140. That is, when people and/or carts are between transceiver 130 and shelving 140, signal 142 does not provide an accurate reflection of signal 141 and may not be capable of being properly matched to known perturbations for given shelves and given item types.

In an embodiment, wireless signal analyzer 111 and/or 121 are configured to obtain and evaluate signals 142 are predefined intervals of time, such as every 30 minutes or 5 minutes. When the signals 142 during a reporting interval include noise, wireless signal analyzer 111 and/or 121 continuously evaluates signals 142 until no known noise is detected in the signals 142.

In an embodiment, terminal 110 processes customer transactions within the store via transaction manager 114.

In an embodiment, terminal 110 is a Point-Of-Sale (POS) terminal, a Self-Service Terminal (SST), a self-checkout terminal, or a kiosk.

In an embodiment, transaction terminal 110 does not include wireless signal analyzer 111, inventory manager 112, or notifier 113; rather all of the above processing with respect to these modules are performed on server 120 via wireless signal analyzer 121, inventory manager 122, and notifier 123.

In an embodiment, there are a plurality of terminals 110, each terminal responsible for a different set of shelving and displays 140 for a specific unique set of items within the store. In this embodiment, the processing discussed above with respect to wireless signal analyzer 121, inventory manager 122, and notifier 123 may be eliminated relying on the wireless signal analyzers 111, inventory managers 112, and notifiers 113 of the terminals 110.

In an embodiment, where the item inventory management is performed by one or more terminals 110, the terminals 110 may only evaluate signals 142 during times that the terminals 110 are not processing a customer checkout transaction based on notifications received from transaction manager 114 or based on monitoring peripheral scanners of terminals 110 for inactivity (indicating that the terminals are likely idle and not performing any customer transactions). This ensures that the processing load is not unduly interruptive of any transaction processing on the terminals 110 during checkouts.

In an embodiment, a given shelf identifier for a given shelf and given item identifiers for a given item are obtained from a planogram for the store. This permits signals 142 to be matched to specific shelves 140 and specific items of given item types by the wireless signal analyzer 111 and/or 121.

One now appreciates how a store's existing hardware infrastructure and wireless network infrastructure may be utilized to achieve item-shelf or item-display inventory management in real time. Reflected wireless signals 142 are analyzed for patterns in disturbances of shapes and motion as perturbations. Known perturbations for a given shelf having a given item type of items indicate a percentage of the fullness or emptiness of item counts on the shelf. Perturbations of real-time evaluated signals 142 are compared and matched (can be a scoring or weighting match) against the known perturbations and custom rules drive an inventory notification and/or restocking notification to specific store personnel and/or an in-store inventory system.

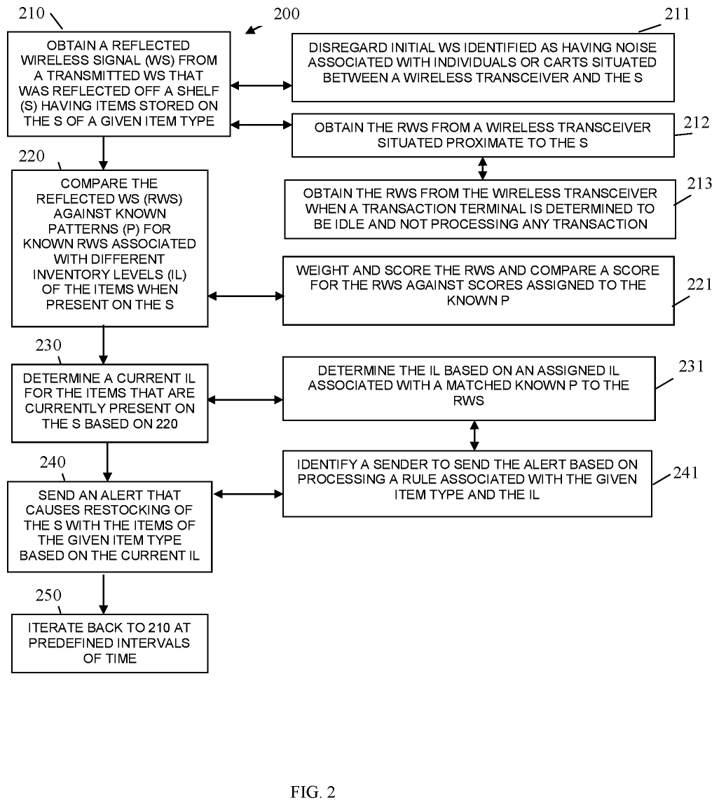

These and other embodiments will now be discussed with reference to FIGS. 2-4.

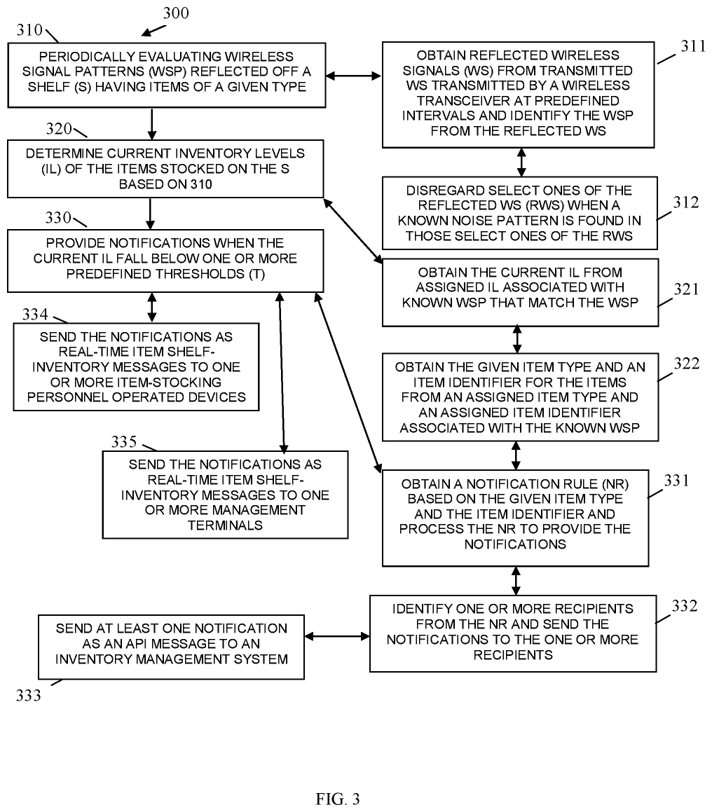

These and other embodiments are now discussed with reference to FIGS. 2-3.

FIG. 2 is a diagram of a method 200 for item inventory management utilizing wireless signals, according to an example embodiment. The software module(s) that implements the method 200 is referred to as an “item-inventory manager.” The item-inventory manager is implemented as executable instructions programmed and residing within memory and/or a non-transitory computer-readable (processor-readable) storage medium and executed by one or more processors of a device. The processor(s) of the device that executes the item-inventory manager are specifically configured and programmed to process the item-inventory manager. The item-inventory manager has access to a wireless network and may or may not also have access to a wired network during operation of the item-inventory manager.

In an embodiment, the device that executes the item-inventory manager is terminal 110. In an embodiment, terminal 110 is a POS terminal, an SST terminal, a checkout terminal, or a kiosk.

In an embodiment, the device that executes the item-inventory manager is a server.

In an embodiment, the item-inventory manager is all of or some combination of: wireless signal analyzer 111, inventory manager 112, notifier 113, wireless signal analyzer 121, inventory manager 122, and/or notifier 123.

At 210, the item-inventory manager obtain a reflected wireless signal 142 from a transmitted wireless signal 141 that was reflected off a shelf 140 having items stored on the shelf of a given item type.

In an embodiment, at 211, the item-inventory manager disregards or ignores initial reflected wireless signals identified as having noises associated with individuals or cards situated between a wireless transceiver 130 and the shelf 140.

In an embodiment, at 212, the item-inventory manager obtains the reflected wireless signal from a wireless transceiver 130 situated proximate to the shelf 140.

In an embodiment of 212, at 213, the item-inventory manager obtains the reflected wireless signal from the wireless transceiver 130 when a transaction terminal 110 is determined to be idle and not processing any transaction. This can be done through notification of transaction manager 114 and/or by monitoring an item bar code scanner for no activity at terminal 110.

At 220, the item-inventory manager compares the reflected wireless signal against known patterns for known reflected wireless signals associated with different inventory levels of the items when present on the shelf. That is, a plurality of known reflected wireless signals are each assigned to the given item time and each associated with a different level of inventory of the items present on the shelf (full, ⅔rds full, ½ full, ⅓ full, empty or any custom percentage relative to being full).

In an embodiment, at 221, the item-inventory manager weights and scores the reflected wireless signal and compares a score for the reflected wireless signal against scores preassigned to the known reflected wireless signals.

At 230, the item-inventory manager determines a current inventory level for the items that are currently present on the shelf based on 220.

In an embodiment, at 231, the item-inventory manager determine the inventory level based on an assigned inventory level with a matched known reflected wireless signal pattern to the reflected wireless signal.

At 240, the item-inventory manager sends an alert that causes restocking of the shelf with the items of the given type based on the current item inventory level.

In an embodiment of 231 and 240, at 241, the item-inventory manager identifies a sender to send the alert based on processing a rule associated with the given item type and the current inventory level.

In an embodiment, at 250, the item-inventory manager iterates back to 210 at predefined intervals of time. The interval of time can be a processing parameter passed to or obtained by the item-inventory manager.

FIG. 3 is a diagram of another method 300 for item inventory management utilizing wireless signals, according to an example embodiment. The software module(s) that implements the method 300 is referred to as a “wireless-signal item-inventory manager.” The wireless-signal item-inventory manager is implemented as executable instructions programmed and residing within memory and/or a non-transitory computer-readable (processor-readable) storage medium and executed by a device. The processors that execute the wireless-signal item-inventory manager are specifically configured and programmed to process the wireless-signal item-inventory manager. The wireless-signal item-inventory manager has access to a wireless network and may also have access to a wired network during operation of the wireless-signal item-inventory manager.

In an embodiment, the device that executes the wireless-signal item-inventory manager is terminal 110. In an embodiment, terminal 110 is a POS terminal an SST, a checkout station, or a kiosk.

In an embodiment, the device that executes the wireless-signal item-inventory manager is server 120.

In an embodiment, the wireless-signal item-inventory manager is all of or some combination of: wireless signal analyzer 111, inventory manager 112, notifier 113, wireless signal analyzer 121, inventory manager 122, notifier 123 and/or the method 200.

The processing of the wireless-signal item-inventory manager as shown in FIG. 3 represents another and in some ways enhanced perspective of the method 200 shown in the FIG. 2.

At 310, the wireless-signal item-inventory manager periodically evaluates wireless signal patterns reflected off a shelf having items of a given type.

In an embodiment, at 311, the wireless-signal item-inventory manager obtains the reflected wireless signal patterns from transmitted wireless signals transmitted by a wireless transceiver 130 at predefined intervals. The wireless-signal item-inventory manager identifies the wireless signal patterns from the reflected wireless signals.

In an embodiment of 311 and at 312, the wireless-signal item-inventory manager disregards select ones of the reflected wireless signals when a known noise pattern is fund in those select reflected wireless signals.

At 320, the wireless-signal item-inventory manager determines current inventory levels of the items stocked on the shelf based on 310.

In an embodiment, at 321, the wireless-signal item-inventory manager obtains the current inventory levels from assigned inventory levels associated with known reflected wireless signal patterns that match to the wireless signal patterns.

In an embodiment of 321 and at 322, the wireless-signal item-inventory manager obtains the given item type and an item identifier for the items from an assigned item type and an assigned item identifier associated with the known wireless signal patterns.

At 330, the wireless-signal item-inventory manager provides notifications when the current inventory levels fall below one or more predefined thresholds.

In an embodiment of 322 and 330, at 331, the wireless-signal item-inventory manager obtains a notification rule based on the given item type and the item identifier and processes the notification rule to provide the notifications.

In an embodiment of 331 and at 332, the wireless-signal item-inventory manager identifies one or more recipients from the notification rule and sends the notifications to the one or more recipients.

In an embodiment of 332 and at 333, the wireless-signal item-inventory manager sends at least one notification as an API message to an inventory management system.

In an embodiment, at 334, the wireless-signal item-inventory manager sends the notifications as real-time item-shelf inventory messages to one or more item-stocking personnel operated devices 150.

In an embodiment, at 335, the wireless-signal item-inventory manager sends the notifications as real-time item-shelf inventory messages to one or more management terminals, such as to POS terminals 110 operated by staff of a store.

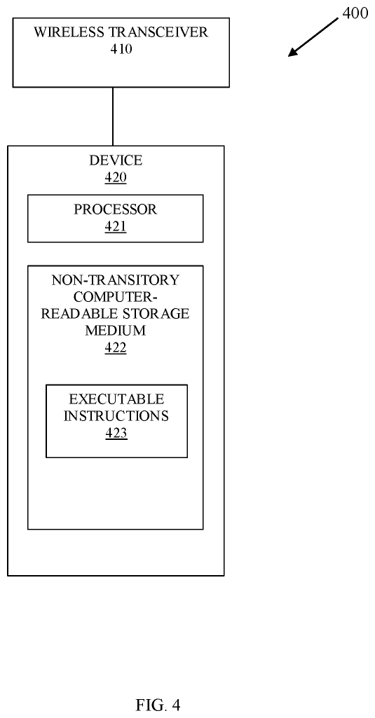

FIG. 4 is a diagram illustrating another system 400 for item inventory management utilizing wireless signals. The system 400 includes a variety of hardware and software that is processed by the hardware. The system 400 has access to one or more networks that may be wired and/or wireless.

In an embodiment, the system 400 is the system 100.

In an embodiment, the system 400 is configured to perform the processing discussed above with the FIGS. 1-3.

The system 400 includes a wireless transceiver 410 and a device 420. The device includes a processor 421 and a non-transitory computer-readable storage medium 422. The non-transitory computer-readable storage medium 422 comprises executable instructions 423.

The executable instructions 423 when executed by the processor 421 from the non-transitory computer-readable storage medium 422 cause the processor 421 to: 1) obtain the reflected wireless signals from the wireless transceiver 410; 2) determine wireless signal patterns from the reflected wireless signals; 3) match the wireless signal patterns to known wireless signals patterns associated with item inventory levels for items present on a shelf; 4) determine whether to send real-time item-inventory notifications based on the item inventory levels; and 5) iterate back to obtaining the reflected wireless signals from the wireless transceiver 410 at predefined intervals of time.

In an embodiment, the wireless transceiver 410 is the wireless transceiver 130.

In an embodiment, the device 420 is the transaction terminal 110. In an embodiment, the terminal 110 is a POS terminal, an SST, a self-checkout terminal, or a kiosk.

In an embodiment, the device 420 is the server 120.

In an embodiment, the executable instructions 423 is all or some combination of: wireless signal analyzer 111, inventory manager 112, notifier 113, wireless signal analyzer 121, inventory manager 122, notifier 123, the method 200 of the FIG. 2, and/or the method 300 of the FIG. 3.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
obtaining a reflected wireless signal from a transmitted wireless signal that was reflected off a shelf having items stored on the shelf of a given item type;
comparing the reflected wireless signal against known patterns for known reflected wireless signals associated with different inventory levels of the items when present on the shelf;
determining a current inventory level for the items that are currently present on the shelf based on the comparing; and
sending an alert that causes restocking of the shelf with the items of the given item type based on the current inventory level.

2. The method of claim 1 further comprising, iterating back to the obtaining at predefined intervals of time.

3. The method of claim 1, wherein obtaining further includes disregarding initial wireless signals identified as having noise associated with individuals or carts situated between a wireless transceiver and the shelf.

4. The method of claim 1, wherein obtaining further includes obtaining the reflected wireless signal from a wireless transceiver situated proximate to the shelf.

5. The method of claim 4, wherein obtaining further includes obtain the reflected wireless signal from the wireless transceiver when a transaction terminal is determined to be idle and not processing any transaction.

6. The method of claim 1, wherein comparing further includes weighting and scoring the reflected wireless signal and comparing a score for the reflected wireless signal against scores assigned to the known patterns.

7. The method of claim 6, wherein determining further includes determining the inventory level based on an assigned inventory level associated with a matched known pattern.

8. The method of claim 7, wherein sending further includes identifying a sender to send the alert based on processing a rule associated with the given item type and the inventory level.

9. A method, comprising:
periodically evaluating wireless signal patterns reflected off a shelf having items of a given item type;
determining current inventory levels of the items on the shelf based on the periodically evaluating; and
providing notifications when the current inventory levels fall below one or more predefined thresholds.

10. The method of claim 9, wherein periodically evaluating further includes obtaining reflected wireless signals from transmitted signals transmitted by a wireless transceiver at predefined intervals and identifying the wireless signal patterns from the reflected wireless signals.

11. The method of claim 10, wherein obtaining further includes disregarding select ones of the reflected wireless signals when a known noise pattern is found in those select ones of the reflected wireless signals.

12. The method of claim 11, wherein determining further includes obtaining the current inventory levels from assigned inventory levels associated with known wireless signal patterns that match the wireless signal patterns.

13. The method of claim 12, wherein obtaining further includes obtaining the given item type and an item identifier for the items from an assigned item type and an assigned item identifier associated with the known wireless signal patterns.

14. The method of claim 13, wherein obtaining further includes obtaining a notification rule based on the given item type and the item identifier and processing the notification rule to provide the notifications.

15. The method of claim 14, wherein processing further includes identifying one or more recipients from the notification rule and sending the notifications to the one or more recipients.

16. The method of claim 15, wherein sending further includes sending at least one notification as an Application Programming Interface (API) message to an inventory management system.

17. The method of claim 9, wherein providing further includes sending the notifications as real-time item shelf-inventory messages to one or more item-stocking personnel operated devices.

18. The method of claim 9, wherein providing further includes sending the notifications as real-time item shelf-inventory messages to one or more management terminals.

19. A system, comprising:
a wireless transceiver configured to transmit first wireless signals and receive reflected wireless signals associated with reflected first wireless signals;
a device comprising a processor and a non-transitory computer-readable storage medium;
the non-transitory computer-readable storage medium comprising executable instructions; and
the executable instructions when executed by the processor from the non-transitory computer-readable storage medium configured to cause the processor to:
obtain the reflected wireless signals from the wireless transceiver;
determine wireless signal patterns from the reflected wireless signals;
match the wireless signal patterns to known wireless signals patterns associated with item inventory levels for items present on a shelf;
determine whether to send real-time item-inventory notifications based on the item inventory levels; and
iterate back to obtaining the reflected wireless signals from the wireless transceiver at predefined intervals of time.

20. The system of claim 19, wherein the device is a Self-Service Terminal (SST), a Point-of-Sale (POS) terminal, a kiosk, a self-checkout terminal, or a server.
